(19) United States
(12) Patent Application Publication
(10) Pub. No.: US 2026/0004137 A1
(43) Pub. Date: Jan. 1, 2026

(54) METHOD AND SYSTEM FOR PROVIDING DOMAIN-ADAPTIVE CHATBOT SERVICES BASED ON LARGE LANGUAGE MODELS

(71) Applicant: LG MANAGEMENT DEVELOPMENT INSTITUTE CO., LTD., Seoul (KR)

(72) Inventors: Joong Bo SHIN, Seoul (KR); Seung Pil WON, Seoul (KR); You Bin AHN, Seoul (KR)

(21) Appl. No.: 19/253,234

(22) Filed: Jun. 27, 2025

(30) Foreign Application Priority Data
Jun. 27, 2024 (KR) 10-2024-0084855
Jun. 17, 2025 (KR) 10-2025-0079838

(51) Int. Cl. G06N 3/0895; G06N 5/04

(52) U.S. Cl. CPC G06N 3/0895; G06N 5/04

(57) ABSTRACT

A method for providing a domain-adaptive chatbot service based on a large language model (LLM) is performed by a computing device including a memory and a processor, and includes generating a plurality of domain-specific structured training prompts, each of which corresponds to a respective one of a plurality of different domains and includes a plurality of labeled intent sample sentences corresponding to the respective one domain, training the LLM based on the plurality of training prompts, receiving a user input query, generating a structured inference prompt including a plurality of labeled intent sample sentences corresponding to a domain of the user input query and the user input query, inputting the inference prompt into the trained LLM, and providing a response to the user input query according to the intent of the user input query determined by the trained LLM based on the inference prompt.

### CROSS-REFERENCE TO RELATED APPLICATIONS

This application claims the benefit of and priority to Korean Patent Application No. 10-2025-0079838, filed on Jun. 17, 2025, and Korean Provisional Patent Application No. 10-2024-0084855, filed on Jun. 27, 2024, the entire disclosures of which are hereby incorporated herein by reference in their entireties.

### BACKGROUND

### Technical Field

The present disclosure generally relates to a method and system for providing a domain-adaptive chatbot service based on a large language model and, more particularly, to a method and system for providing a domain-adaptive chatbot service based on a large language model, which can improve both domain adaptability and implementation efficiency by pre-training the large language model using a prompt containing an intent-specific sample sentence of each domain in order to accurately classify intents of user input queries across various domains, and performing intent classification for a new domain using only a one-shot example.

### Related Art

Artificial intelligence (AI) technology has made remarkable advances in recent years, bringing about innovative changes across society. In particular, the development of deep learning and machine learning algorithms has significantly improved the ability of AI systems to learn from and make predictions based on complex data. These technological advancements have led to practical applications in various fields such as speech recognition, image processing, and natural language processing (NLP), contributing to improving the quality of human life.

At the core of these advancements in artificial intelligence is the emergence of large language models (LLMs). Various commercial LLMs are trained on massive amounts of text data to generate human-like text or natural language text, thereby demonstrating sophisticated language understanding capabilities and driving technological innovation.

Along with the advancement of language models, chatbot service technology has also significantly improved. Early chatbots were limited to simple rule-based systems capable of performing only basic conversations, but modern chatbots can respond to complex questions, understand user intent, and deliver personalized services. Chatbots are utilized in various fields such as customer service, education, and healthcare, thereby becoming important tools that provide users with necessary information and solve problems any time. These technological advancements have greatly contributed to improving user experience and enhancing operational efficiency for businesses.

One of core components of such chatbots is an intent classification module, which accurately identifies the intent behind a user's question. Intent classification serves as a foundational technology that interprets the user's needs or question types to determine the appropriate response or task for the chatbot to perform, and is a factor directly related to service quality and user satisfaction.

For example, in an intent classification system, a large number of learning data is collected for each predefined intent label and a small-scale classification model (e.g., Bidirectional Encoder Representations from Transformers (BERT), Convolutional Neural Network (CNN), etc.) is fine-tuned based on the data. However, the intent classification system fine-tuned in this manner has limitations in that when expanding or adapting the chatbot to a new domain, as it requires the collection of new domain-specific data and a separate model retraining process, thereby resulting in significant development costs and time consumption.

To overcome these limitations, recent attention has been focused on an intent classification method that utilizes the LLM based on few-shot or one-shot learning. Various commercial closed LLMs possess the capability to perform high-accuracy intent classification even in unseen domains, using only a few examples, despite having no prior training on those domains. This is because a super-large language model is pre-trained on vast amounts of general-purpose data, and its training architecture may generalize across diverse contexts and language patterns.

However, the commercial closed LLMs not only pose a cost burden and come with restrictive licensing policies, but also allow access only through Application Programming Interface (API) calls, and therefore may impose various limitations in practical work environments. For example, a structure that requires internal customer data to be transmitted to an external server may pose security risks, and the inability to directly modify or control the model's operation method or parameters imposes limitations on system integration and customization. In addition, the impossibility of on-premise deployment, where models are directly installed and used on internal enterprise servers, may make it difficult to apply in industries with advanced data control and infrastructure requirements (e.g., finance, healthcare, public institutions).

As a result, there have been ongoing efforts to utilize open-source-based Open LLMs. However, these models have limitations in that the scope and quality of their training data are relatively restricted compared to the closed LLMs, leading to lower zero-shot or one-shot classification performance, particularly in unseen domains.

One existing approach to address this limitation is to perform data augmentation using an in-context training ability, which induces the model to infer patterns similar to examples provided in the context by providing a small number of examples (utterance-label pairs) within an input prompt of the Open LLM, and then fine-tuning a separate intent classifier utilizing data generated by the augmentation.

However, this approach still requires additional training procedures for the intent classifier and developer intervention, resulting in low maintenance efficiency. Therefore, there is a need for research on a methodology that enables the Open LLM to accurately classify intents even in unseen domains through a new, more efficient method other than separate parameter updates or complex model structure changes.

### SUMMARY

Some embodiments of the present disclosure may provide a method and system for providing a domain-adaptive chatbot service based on a large language model, which can pre-train the LLM based on a prompt including a one-shot example for each intent, and perform effective intent classification based on the prompt including the one-shot example for a new domain using the trained model, in order to provide a chatbot service that can perform high-accuracy intent classification using only a small number of training examples in various domains.

Certain embodiments of the present disclosure may provide a method and system for providing a chatbot service, which can construct a general-purpose chatbot system utilizing an intent classification model capable of performing accurate intent classification using a natural language prompt that includes a user input query, a corresponding domain's intent list and examples, and can quickly adapt to a newly added domain by constructing an intent sample sentence.

Some embodiments of the present disclosure may provide a method and system for providing a domain-adaptive chatbot service, which utilizes an open-source-based large language model while ensuring intent classification performance that surpasses that of a closed LLM, thereby improving cost efficiency and flexibility in service deployment.

However, the technical objectives to be solved by various embodiments of the present disclosure are not limited to the above-mentioned objectives, and other technical objectives may also exist.

In an aspect, a method for providing a domain-adaptive chatbot service based on a large language model (LLM), which is performed by a computing device including a memory and a processor, is provided. The method may include generating a plurality of domain-specific structured training prompts, each of which corresponds to a respective one of a plurality of different domains and includes a plurality of labeled intent sample sentences corresponding to that domain; performing training of the LLM based on the plurality of training prompts; receiving a user input query; generating a structured inference prompt including a plurality of labeled intent sample sentences corresponding to a domain of the user input query and the user input query; inputting the inference prompt into the trained LLM; and providing a response to the user input query according to the intent of the user input query determined by the trained LLM based on the inference prompt.

In another aspect, each of the plurality of training prompts may include an intent classification task instruction.

In another aspect, each of the plurality of training prompts may include a plurality of intent information pairs, each intent information pair including an intent label related to a corresponding domain and an intent sample sentence corresponding to the intent label.

In another aspect, each of the plurality of training prompts may further include a query related to the same domain as the plurality of intent information pairs.

In another aspect, the performing the training of the LLM may include training the LLM using the intent label corresponding to the query as ground truth data.

In another aspect, the generating the inference prompt may include determining a domain of the user input query; and generating the inference prompt, the inference prompt comprising a plurality of intent information pairs, each intent information pair including an intent label related to the determined domain of the user input query and an intent sample sentence corresponding to the intent label.

In another aspect, the generating the plurality of training prompts may include generating a first plurality of domain-specific structured training prompts, each of which corresponds to a respective one of a plurality of different domains and includes a plurality of first labeled intent sample sentences corresponding to that domain; and generating a second plurality of domain-specific structured training prompts, each of which corresponds to a respective one of a plurality of different domains and includes a plurality of second labeled intent sample sentences corresponding to that domains. A first intent sample sentence for a first intent included in a training prompt corresponding to a first domain among the first plurality of training prompts may be different from a second intent sample sentence for the first intent included in a training prompt corresponding to the first domain among the second plurality of training prompts.

In another aspect, the performing the training of the LLM may include training the LLM based on the first plurality of training prompts; and training the LLM based on the second plurality of training prompts.

In an aspect, a system for providing a domain-adaptive chatbot service based on a large language model (LLM) is provided. The system may include at least one memory, and at least one processor configured to read at least one instruction stored in the memory and perform a method for providing the domain-adaptive chatbot service based on the LLM. The at least one processor generates a plurality of domain-specific structured training prompts, each of which corresponds to a respective one of a plurality of different domains and includes a plurality of labeled intent sample sentences corresponding to that domain; performs training of the LLM based on the plurality of training prompts; receives a user input query; generates a structured inference prompt including a plurality of labeled intent sample sentences corresponding to a domain of the user input query and the user input query; inputs the inference prompt into the trained LLM, and provides a response to the user input query according to the intent of the user input query determined by the trained LLM based on the inference prompt.

In another aspect, the system may include a plurality of neurons configured as an array including at least one register, at least one programmable logic, and at least one input interface; a plurality of synapse circuits configured to store a synapse weight for adjusting a connection strength between the plurality of neurons; and at least one routing network configured to control data flow between the plurality of neurons. Each of the plurality of neurons may further include a field programmable gate array (FPGA) implementation for a predetermined artificial neural network, which is connected to at least one other neuron via the routing network to establish a transmission path of the weight.

In another aspect, the system may include a plurality of neurons organized in an array including at least one register, at least one microprocessor, and at least one input; and a plurality of synapse circuits configured to store a synapse weight for adjusting a connection strength between the plurality of neurons. Each of the plurality of neurons may further include an application-specific integrated circuit (ASIC) for a predetermined artificial neural network, which is connected to at least one other neuron via any one of the plurality of synapse circuits.

According to various embodiments of the present disclosure, effective intent classification can be performed even in new domains using only one-shot examples in a fixed model state, by generalizing intent classification performance for various domains through a pre-training process based on a large language model, so that a high-performance chatbot service including an intent classification system capable of accurately classifying intents based on prompts can be easily built.

Further, some embodiments of the present disclosure may provide a chatbot service system that allows easy addition and modification of domains and can flexibly respond to various domains by utilizing a natural language-based prompt that includes an intent list and example sentence for each domain

Furthermore, certain embodiments of the present disclosure may provide a high-performance chatbot service system that is optimized for independent service deployment by enterprises and institutions while reducing model usage costs by utilizing an open-source-based LLM while ensuring intent classification performance that surpasses that of a closed LLM.

In addition, some embodiments of the present disclosure may construct a highly efficient chatbot service providing system that can be universally applied in various application environments by combining a prompt-based learning structure and a one-shot inference method, model scalability and deployment flexibility can be secured simultaneously.

Effects that can be obtained through various embodiments of the present disclosure are not limited to the above-mentioned effects, and other effects that are not mentioned above will be clearly understood from the following description.

### BRIEF DESCRIPTION OF THE DRAWINGS

FIG. 1 is a block diagram illustrating a computing system for providing a domain-adaptive chatbot service based on a large language model according to an embodiment.

FIG. 2 is a schematic view illustrating a structure of a neuromorphic circuit that may be included by a processor according to an embodiment.

FIG. 3 is a block diagram illustrating a computing device for providing a domain-adaptive chatbot service based on a large language model according to an embodiment.

FIG. 4 is a block diagram illustrating a computing device for providing a domain-adaptive chatbot service based on a large language model according to another embodiment.

FIG. 5 is a block diagram illustrating a functional configuration of a processor of a server computing system according to an embodiment.

FIG. 6 is a block diagram illustrating a functional configuration of an intent classification module included in a processor of a server computing system according to an embodiment.

FIGS. 7 and 8 illustrate examples of a data set including a plurality of intent labels for each of a plurality of domains and a plurality of sample sentences corresponding to each intent label according to an embodiment.

FIG. 9 illustrates an exemplary configuration of a prompt that is input to a large language model for pre-training for intent classification according to an embodiment.

FIG. 10 is a table showing performance evaluation results of one-shot intent classification performed using a large language model trained based on a predetermined prompt for various domains according to an embodiment.

FIG. 11 is a flowchart illustrating a method for providing a domain-adaptive chatbot service based on a large language model according to an embodiment.

### DETAILED DESCRIPTION

Since the present disclosure may be changed in various ways and have various embodiments, specific embodiments are illustrated in the drawings and described in detail in a detailed description. The effects and features of the present disclosure and the method for achieving them will become clear with reference to the embodiments described in detail below together with the drawings. The present disclosure may, however, be embodied in various forms without being limited to only the embodiments set forth herein. It will be understood that, although the terms “first”, “second”, etc. may be used herein to describe various components, these components should not be limited by these terms. These terms are only used to distinguish one component from another component. Further, the singular forms are intended to include the plural forms as well, unless the context clearly indicates otherwise. It will be further understood that the terms “comprise”, “include”, “have”, etc. when used in this specification, specify the presence of stated features or components but do not preclude the presence or addition of one or more other features or components. Furthermore, the size or thickness of components shown in the drawings may be exaggerated for the convenience of description. For example, the size and thickness of each component shown in the drawing are provided merely for illustrative purposes, and thus the present disclosure is not necessarily limited thereto.

Hereinafter, the exemplary embodiments of the present disclosure will be explained in detail with reference to the accompanying drawings. The same reference numerals are used throughout the drawings to designate the same or similar components, and a duplicated description thereof will be omitted herein.

### -System 1000 for Providing Domain-Adaptive Chatbot Service Based on Large Language Model

A system 1000 according to an embodiment utilizes the instruction inference capability of a large language model (LLM), i.e., the ability to generate an appropriate response based on a task instruction given in natural language, thereby providing a general-purpose chatbot service capable of effectively responding to a user query across various domains through a one-shot based intent classification method that enables high-accuracy intent classification for each intent using only a single example, even in an unseen or new domain.

In particular, the system 1000 may provide a general-purpose chatbot service that may flexibly respond to a new domain by utilizing a large language model pre-trained using a predetermined fixed format of a natural language-based prompt.

A conventional intent classification system requires a large amount of learning data for a specific domain, and needs to perform separate fine-tuning and labeling task before applying a new domain. Accordingly, there were limitations in development cycle and deployment efficiency, and practicality, especially in real-world service environment that should respond to a plurality of domains.

In contrast, the system 1000 according to various embodiments of the present disclosure can perform flexible and effective intent classification for a new domain based on the ability of understanding natural language and versatility of a large language model, thereby providing a general-purpose chatbot service that can respond to user queries across various domains quickly and accurately.

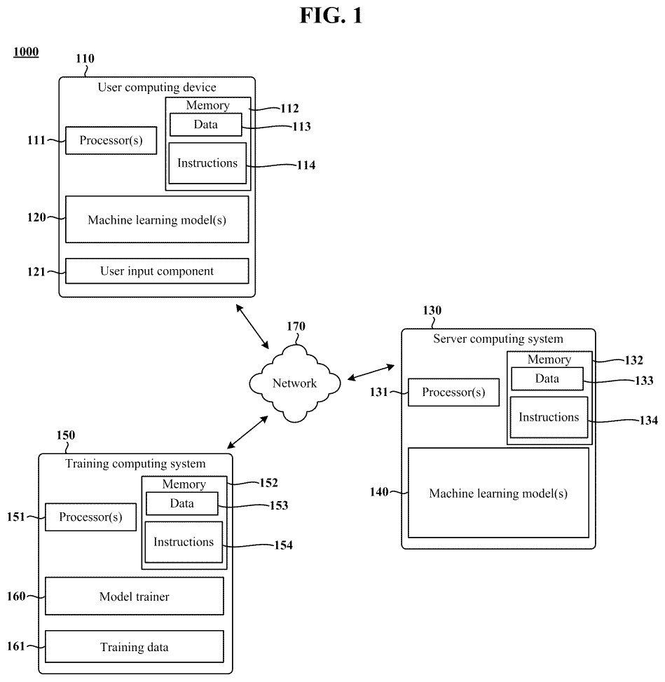

FIG. 1 is a block diagram illustrating a computing system 1000 that implements a domain-adaptive chatbot service based on a large language model according to an embodiment.

Referring to FIG. 1, the computing system 1000 implementing the domain-adaptive chatbot service based on the large language model according to an embodiment includes a user computing device or a user computer 110, a server computing system, a server computer, or a server 130, and a training computing system or a training computer 150, which may communicate with each other via a network 170.

A method for providing a domain-adaptive chatbot service based on a large language model according to an embodiment may be implemented and provided in one or more of the following ways: 1) by the user computing device 110 locally, 2) by the server computing system 130 that communicates with the user computing device 110 in the form of a web service, and 3) through a combination of the user computing device 110 and the server computing system 130.

In an embodiment, the user computing device 110 and/or the server computing system 130 may train machine learning models 120 and/or 140 through interaction with a training computing system 150 that is communicatively connected with the user computing device 110 and/or the server computing system 130 via the network 170. The training computing system 150 may be a system separate from the server computing system 130 or may be part of the server computing system 130.

At this time, an artificial intelligence model may be 1) directly trained locally by the user computing device 110, 2) trained by the server computing system 130 and the user computing device 110 interacting with each other via the network 170, and 3) trained by a separate training computing system 150 using training techniques and learning techniques. According to an embodiment, the training computing system 150 may provide and update the trained artificial intelligence model by transmitting it to the user computing device 110 and/or the server computing system 130 via the network 170.

In some embodiments, the training computing system 150 may be part of the server computing system 130 or part of the user computing device 110.

### -User Computing Device 110

The user computing device 110 may include any type of computing devices, such as a smart phone, a mobile phone, a digital broadcasting device, a personal digital assistant (PDA), a portable multimedia player (PMP), a desktop, a wearable device, an embedded computing device, and/or a tablet personal computer (PC).

In an embodiment, the user computing device 110 may further include a server computing device or a server that provides the domain-adaptive chatbot service environment based on the large language model.

Such a user computing device 110 includes at least one processor 111 and a memory 112.

Here, the processor 111 of the user computing device 110 may comprise at least one or a plurality of processors electrically connected among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing intended functions.

For example, the processor 111 may be configured based on the Field Programmable Gate Array (FPGA) implementation, which is a hardware technology for implementing a predetermined digital circuit, and/or an Application Specific Integrated Circuit (ASIC).

Here, the FPGA implementation may mean a flexible digital circuit that may be programmed according to user needs.

In an embodiment, the FPGA implementation may include a register that temporarily stores data and controls the flow and timing of a signal to maintain intermediate computation results or state information, thereby supporting synchronized operations of the FPGA, a programmable logic that programs the operations inside the FPGA to perform specific functions or operations as configurable logic circuits according to user needs, and an input interface that receives a signal from an external device or a sensor as a channel for receiving data from outside the FPGA.

By combining one or more of the above described components, the FPGA implementation may provide flexible and diverse forms of digital circuits.

Meanwhile, the ASIC may refer to a customized integrated circuit that is fixedly designed to perform a specific purpose or function.

In an embodiment, the ASIC may include a register that is a small memory device, which temporarily stores and manages data, to store intermediate computation results or state information, thereby supporting the fast operation of the ASIC, a microprocessor that functions as a central processing unit for performing control and operations within the ASIC to perform various operations or generate control signals as needed, thereby coordinating the overall operation of the system, and an input block that serves as an interface for receiving data from an external source, receives data that is to be processed by the ASIC, transmits the data internally, and receives various pieces of input data through connection with sensors or external devices.

By combining one or more of the above described components, the application-specific integrated circuit may perform a specific task in an optimized manner.

For example, the ASIC may have a structure of a neuromorphic circuit in the form of an array including a plurality of neuron circuits.

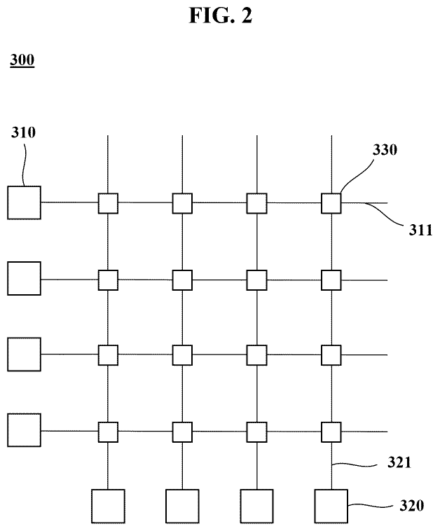

FIG. 2 is a schematic view illustrating the structure of a neuromorphic circuit 300 that may be included in the processor 111 according to an embodiment.

Referring to FIG. 2, for example, the neuromorphic circuit 300 may include a plurality of pre-synaptic neuron circuits 310, a plurality of pre-synaptic lines 311 extending laterally from the plurality of pre-synaptic neuron circuits 310, a plurality of post-synaptic neuron circuits 320, a plurality of post-synaptic lines 321 extending longitudinally from the plurality of post-synaptic neuron circuits 320, and a plurality of synapse circuits 330 provided on intersections between the plurality of pre-synaptic lines 311 and the plurality of post-synaptic lines 321.

The plurality of pre-synaptic neuron circuits 310 may transmit signals input from the outside the computing system 1000 through the plurality of pre-synaptic lines 311 to the plurality of synapse circuits 330 in the form of electrical signals.

Further, the plurality of post-synaptic neuron circuits 320 may receive the electrical signals from the plurality of synapse circuits 330 through the plurality of post-synaptic lines 321.

Moreover, the plurality of post-synaptic neuron circuits 320 may transmit the electrical signal through the plurality of post-synaptic lines 321 to the plurality of synapse circuits 330.

The plurality of synapse circuits 330 may store weights included in layers constituting a neural network system implemented by the neuromorphic circuit 300, and may perform a predetermined operation based on the weights and input data.

For example, each of the synapse circuits 330 may include a resistive memory cell having a variable resistance. In this case, the plurality of synapse circuits 330 may change their resistance values in response to voltages applied through the plurality of pre-synaptic neuron circuits 310 or the plurality of post-synaptic neuron circuits 320, and may store weight data corresponding to such resistance change.

The neuromorphic circuit 300 is formed by simulating neuron and synapse structures, which are essential elements of the human brain. When a deep neural network (DNN) is implemented using the neuromorphic circuit 300, data processing speed can be improved and power consumption can be reduced compared to an existing von Neumann structure.

The memory 112 of the user computing device 110 may include one or more non-transitory/transitory computer-readable storage media, such as RAM, ROM, EEPROM, EPROM, flash memory devices, magnetic disks, and combinations thereof, and may include web storage of a server performing the storage function of memory on the internet. The memory 112 may store data 113 and instructions 114 for performing functional operations, such as training an artificial intelligence model or constructing a prompt used to perform intent classification pre-training for a large language model, by the processor 111.

In an embodiment, the user computing device 110 may perform various deep-learning tasks for the domain-adaptive chatbot service based on the large language model in conjunction with the deep-learning neural network.

Here, the deep-learning neural network according to an embodiment may include a Convolution Neural Network (CNN), R-CNN (Regions with CNN features), Fast R-CNN, Faster R-CNN, Mask R-CNN, and the like, and may encompass any deep-learning neural network that includes algorithms capable of performing one or more embodiments described herein. The present disclosure is not limited or restricted to the deep-learning neural network.

According to an embodiment, the deep-learning neural network may be installed directly in the server computing system 130 or may operate as a separate device from the server computing system 130 to perform deep-learning for the domain-adaptive chatbot service based on the large language model.

Further, in an embodiment, the user computing device 110 may store at least one machine learning model 120.

For example, the user computing device 110 may include various machine learning models, such as a plurality of neural networks (e.g., deep neural networks) that perform a large language model-based domain-adaptive chatbot service providing method based on structured/quantitative data, as well as other types of machine learning models including non-linear and/or linear models, and may be configured as a combination thereof.

By way of example, the machine learning model may include linear regression, decision trees, random forests, gradient boosting, pre-trained language models, and/or deep learning models. The neural network may include at least one of feed-forward neural networks, recurrent neural networks (e.g., long short-term memory recurrent neural networks), convolution neural networks, and/or other types of neural networks.

According to an embodiment, the user computing device 110 may store a model to be used in each process and a prompt template that serves as the basis for input to the model, in order to perform at least some processes of the method for providing the domain adaptive chatbot service based on a large language model (LLM) through the LLM.

In an embodiment, the user computing device 110 may receive at least one machine learning model 120 from the server computing system 130 via the network 170, store it in the memory 112, and then execute the stored machine learning model 120 via the processor 111 to perform domain classification of a user input query, etc.

In another embodiment, the user computing device 110 may provide the domain-adaptive chatbot service based on the large language model to a user by performing an operation through the machine learning model 140 including at least one machine learning model 140 in conjunction with the server computing system 130 and communicating data related thereto with the outside of the computing system 1000.

For example, the user computing device 110 may provide the domain-adaptive chatbot service based on the large language model in such a way that the server computing system 130 provides output for the user's input using the machine learning model 140 via the web.

Further, the artificial intelligence model may be implemented in such a way that one or more of the machine learning models 120 and/or 140 are executed on the user computing device 110 and the rest are executed on the server computing system 130.

The user computing device 110 may include an input component 121 that detects user input.

The user input component 121 may include, for example, but not limited to, a touch sensor (e.g., a touch screen and/or a touch pad, etc.) that detects the touch of a user's input medium (e.g., a finger or a stylus), an image sensor that detects the user's motion input, a microphone that detects the user's voice input, a button, a mouse, and/or a keyboard, etc.

Here, the image sensor may include an image processing module or an image processor. In detail, the image sensor may process a still image or a moving image obtained by an image sensor device (e.g., a charge coupled device (CMOS) or a complementary metal oxide semiconductor (CCD)).

In addition, the image sensor may process a still image or moving image acquired through the image sensor device using an image recognition process (e.g., optical character recognition (OCR), etc.) and/or an image processing module to extract necessary information and transmit the extracted information to the processor.

Further, the input component 121 may receive input for an external controller (e.g., mouse, keyboard, etc.) based on an interface module. The input component 121 may include an external output device (e.g., speaker).

The interface module may include one or more of a wired/wireless headset port, an external charger port, a wired/wireless data port, a memory card port, a port for connecting a device equipped with an identification module, an audio I/O (Input/Output) port, a video I/O (Input/Output) port, an earphone port, a power amplifier, an RF circuit, a transceiver, and/or other communication circuits.

Further, the external output device may include a display system that outputs various pieces of information related to the domain-adaptive chatbot service based on the large language model as a graphic image.

The display system may include one or more of, for example, but not limited to, a liquid crystal display (LCD), a thin film transistor-liquid crystal display (TFT LCD), an organic light-emitting diode (OLED), a flexible display, a 3D display, and an e-ink display.

Meanwhile, the user computing device 110 including one or more of the above-described components may further perform at least some of the functional operations performed by the server computing system 130 described below.

### -Server Computing System 130

The server computing system 130 may perform a series of processes to provide the domain-adaptive chatbot service based on the large language model.

In detail, in an embodiment, the server computing system 130 may provide the domain-adaptive chatbot service based on the large language model by exchanging data necessary to drive the domain-adaptive chatbot service process based on the large language model in an external device, such as the user computing device 110, with the external device.

In more detail, in an embodiment, the server computing system 130 may provide an environment in which an application may operate on the user computing device 110.

To this end, the server computing system 130 may include application programs, data and/or instructions necessary for the operation of the application, and may transmit and receive various pieces of data based thereon to and from the external device.

Further, the server computing system 130 includes at least one processor 131 and memory 132.

For instance, the processor 131 of the server computing system 130 may comprise one or a plurality of electrically connected processors, selected from among a central processing unit (CPU), a graphics processing unit (GPU), application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and/or other electrical units for performing functions.

According to an embodiment, the processor 131 may be configured based on the Field Programmable Gate Array (FPGA) implementation and/or the Application Specific Integrated Circuit (ASIC), which are hardware technologies for implementing predetermined digital circuits. A detailed description thereof is omitted by applying the foregoing explanations of the FPGA and ASIC.

The memory 132 may include one or more non-transitory and/or transitory computer-readable storage media, such as RAM, ROM, EEPROM, EPROM, flash memory devices, magnetic disks, or combinations thereof. The memory 132 may store data 133 and instructions 134 for performing functions such as generating prompts to be input into the large language model for pre-training across various domains, or performing the large language model-based intent classification using prompts that include user input queries and one-shot example for each domain.

In an embodiment, the server computing system 130 may include one or more of a computing device, a computer, and/or a server. For example, the server computing system 130 may be implemented to operate a plurality of computing devices according to a sequential computing architecture, a parallel computing architecture, or a combination thereof. Further, the server computing system 130 may include a plurality of computing devices connected via the network 170.

The server computing system 130 may store at least one machine learning model 140. For example, the server computing system 130 may include a neural network and/or other multi-layer non-linear models as the machine learning model 140. Examples of the neural network may include a feed-forward neural network, a deep neural network, a recurrent neural network, and a convolution neural network.

In an embodiment, the server computing system 130 may further include a data store computing system (hereinafter referred to as “data store”), which serves as a storage for continuously storing and managing raw data that forms the basis of the large language model-based domain-adaptive chatbot service.

The data store may include various types of data storage, ranging from a file system to cloud storage. For example, the data store may include at least one type of database, such as: a relational database that uses Structured Query Language (SQL) to define and manipulate data, a NoSQL database designed for flexibility and scalability to process unstructured and semi-structured data, a data warehouse that is a system configured for reporting and data analysis and centralizes large volumes of data from a plurality of sources to be optimized for query and analysis, a data warehouse that stores large volumes of raw data in its native format, including structured, semi-structured, and unstructured data, and a local storage device or Network Attached Storage (NAS) that stores data in a file format accessible by a computer operating system.

### -Training Computing System 150

The training computing system 150 includes at least one processor 151 and memory 152.

Here, the processor 151 of the training computing system 150 may include one or a plurality of electrically connected processors, selected from among a central processing unit (CPU), a graphics processing unit (GPU), application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and/or other electrical units for performing functions.

For instance, according to an embodiment, the processor 151 may be configured based on the Field Programmable Gate Array (FPGA) implementation and/or the Application Specific Integrated Circuit (ASIC), which are hardware technologies for implementing predetermined digital circuits. A detailed description thereof is omitted by applying the foregoing explanations of the FPGA and ASIC.

The memory 152 may include one or more non-transitory and/or transitory computer-readable storage media, such as RAM, ROM, EEPROM, EPROM, flash memory devices, magnetic disks, or combinations thereof. The memory 152 may store data 153 and instructions 154 necessary for the processor 151 to perform a task such as training the artificial intelligence model.

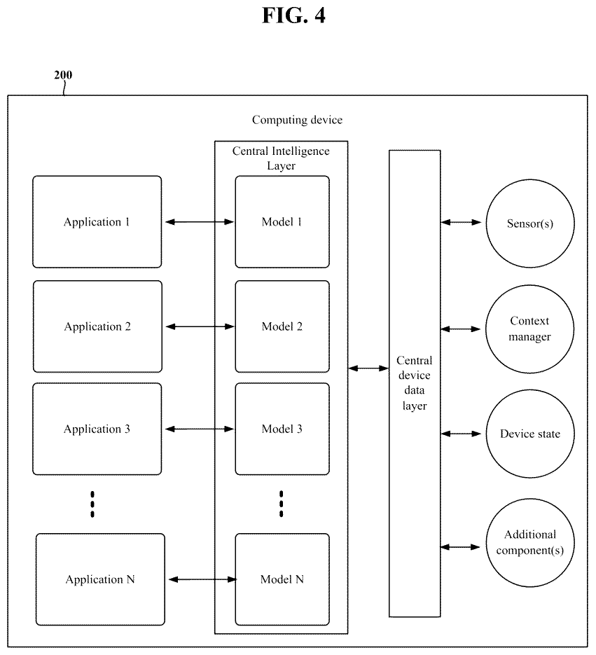

For example, the training computing system 150 may include a model trainer 160 that trains the machine learning model(s) 120 and/or 140 stored in the user computing device 110 and/or the server computing system 130, using various training or learning techniques such as error backpropagation, in accordance with a framework illustrated in FIG. 4.

By way of example, the model trainer 160 may perform updates to one or more parameters of the machine learning model(s) 120 and/or 140 for the large language model-based domain-adaptive chatbot service using backpropagation, based on a defined loss function.

In some embodiments, performing error backpropagation may include performing truncated backpropagation through time. The model trainer 160 may apply various generalization techniques, such as weight decay, dropout, and/or knowledge distillation, to improve the generalization capability of the machine learning model(s) 120 and/or 140 being trained.

The model trainer 160 may also train the machine learning model(s) 120 and/or 140 based on a series of training data 161. The training data 161 may include data in various formats, such as images, audio samples, and/or text. Examples of image types that may be used may include video frames, LiDAR point clouds, X-ray images, computed tomography (CT) scans, hyperspectral images, and/or various other forms of images.

The training data 161 may be provided by the user computing device 110 and/or the server computing system 130. When the training computing system 150 trains the machine learning model(s) 120 and/or 140 on specific data from the user computing device 110, the machine learning model(s) 120 and/or 140 may be specialized as a personalized model.

The model trainer 160 also includes computer logic that is utilized to provide a desired functionality.

The model trainer 160 may be implemented as hardware, firmware, and/or software that controls a general-purpose processor. In one embodiment, the model trainer 160 may include program files stored in the storage device, and loaded in the memory 152 and executed by one or more processors 151. In another embodiment, the model trainer 160 includes one or more sets of computer-executable data 153 and instructions 154 stored on a tangible computer-readable storage medium, such as RAM, a hard disk, or an optical or magnetic medium.

The network 170 may include, for instance, but not limited to, a 3GPP (3rd Generation Partnership Project) network, an LTE (Long Term Evolution) network, a WiMAX (World Interoperability for Microwave Access) network, the Internet, a LAN (Local Area Network), a Wireless LAN (Wireless Local Area Network), a WAN (Wide Area Network), a PAN (Personal Area Network), a Bluetooth network, a satellite broadcasting network, an analog broadcasting network, and/or a DMB (Digital Multimedia Broadcasting) network.

In general, communication over the network 170 may be performed using any type of wired and/or wireless connection, through various communication protocols (e.g., TCP/IP, HTTP, SMTP, and/or FTP), encoding or formats (e.g., HTML and/or XML), and/or security schema (e.g., VPN, secure HTTP, and/or SSL).

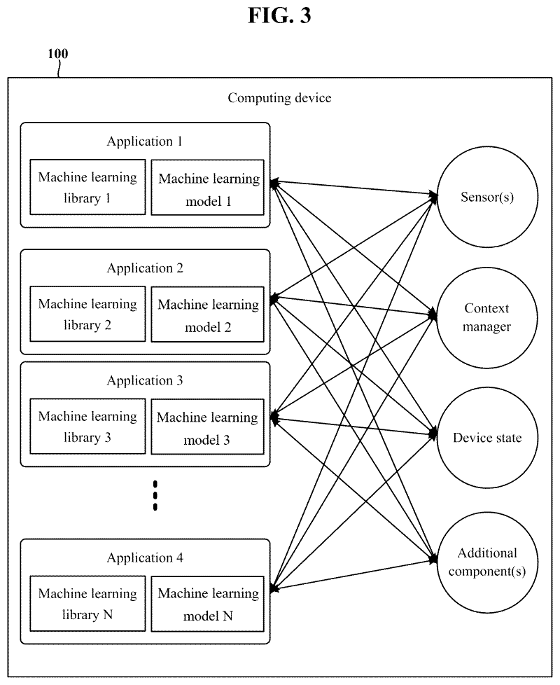

FIG. 3 is a block diagram illustrating a computing device 100 that implements a domain-adaptive chatbot service based on a large language model according to an embodiment.

Referring to FIG. 3, the computing device 100 included in one or more of the user computing device 110, the server computing system 130, and the training computing system 150 may include a plurality of applications (e.g., Application 1 to Application N). Each application may include a machine learning library and one or more machine learning models. For example, the application may include applications for image processing (e.g., detection, classification, and/or segmentation), text messaging applications, email applications, dictation applications, virtual keyboard applications, browser applications, and/or chatbot applications.

In an embodiment, the computing device 100 may include the model trainer 160 for training the artificial intelligence model, and may provide output data based on predetermined input data (e.g., a conversation dataset in an embodiment) by storing and operating the trained artificial intelligence model.

Each application of the computing device 100 may communicate with various other components of the computing device 100, such as at least one sensor, a context manager, a device state component, and/or additional components. In an embodiment, each application may communicate with the respective device component using an API (e.g., a public API). In an embodiment, the API used by each application may be specific to that application.

FIG. 4 is a block diagram illustrating a computing device 200 that implements a domain-adaptive chatbot service based on a large language model according to another embodiment.

Referring to FIG. 4, the computing device 200 may include a plurality of applications (e.g., Application 1 to Application N). Each application may communicate with a central intelligence layer. For example, the application may include image processing applications, text messaging applications, email applications, dictation applications, virtual keyboard applications, and/or browser applications. In an embodiment, each application may communicate with the central intelligence layer (and the model stored therein) using the API (e.g., a common API shared across all applications).

The central intelligence layer may include a plurality of machine learning models. For example, as shown in FIG. 4, one or more of the machine learning models may be provided for each application and may be managed by the central intelligence layer. In another embodiment, two or more applications may share a single machine learning model. For example, in some embodiments, the central intelligence layer may provide a single model for all applications. In some embodiments, the central intelligence layer may be included in the operating system of the computing device 200 or may be implemented separately from the operating system of the computing device 200.

The central intelligence layer may communicate with a central device data layer. The central device data layer may serve as centralized data storage for the computing device 200. As illustrated in FIG. 4, the central device data layer may communicate with various other components of the computing device 200, such as one or more sensors, a context manager, a device state component, and/or additional components. In some embodiments, the central device data layer may communicate with each device component using the API (e.g., a private API).

The technology described herein may refer to servers, databases, software applications, and other computer-based systems, as well as actions and information transmitted to or from such systems. It will be recognized that the inherent flexibility of computer-based systems allows for a wide range of possible configurations, combinations, divisions of tasks, and functionalities among and from components. For example, the processes described herein may be implemented using a single device or component, or a plurality of devices or components operating in combination. Databases and applications may be implemented on a single system or on a system distributed across a plurality of systems. Distributed components may operate sequentially or in parallel.

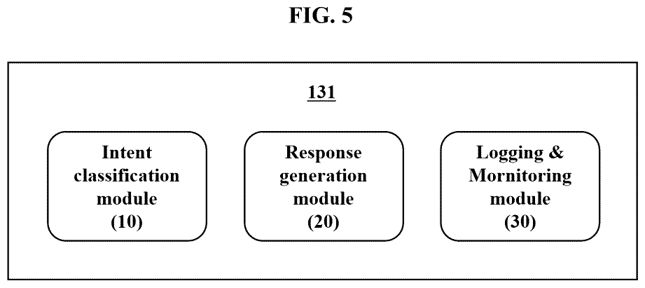

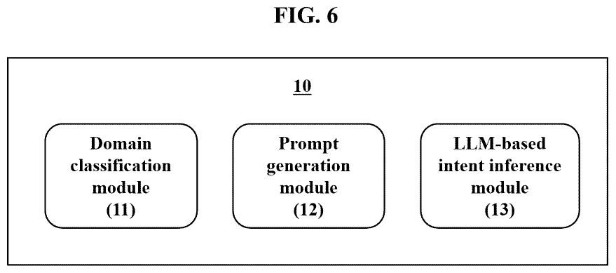

FIG. 5 is a block diagram illustrating a functional configuration of the processor 131 of the server computing system 130 according to an embodiment. FIG. 6 is a block diagram illustrating a functional configuration of an intent classification module 10 included in the processor 131 of the server computing system 130 according to an embodiment.

Referring to FIG. 5, the processor 131 that performs a method for providing a domain-adaptive chatbot service based on a large language model according to various embodiments of the present disclosure may execute or perform functions of the intent classification module 10, a response generation module 20, and a logging and monitoring module 30.

The intent classification module 10 may be configured to determine a domain and an intent label for a user input query. In particular, the intent classification module 10 may generate a prompt in natural language form and input the prompt into the LLM to infer the intent.

In this case, the LLM may be deployed locally or integrated via an external API call, and may utilize a set of predefined one-shot examples for various domains. Further, the server computing system 130 may pre-train (e.g., through fine-tuning or instruction tuning) the parameter of the LLM based on a plurality of domains and intent sample information for each domain, in order to improve the accuracy of intent classification.

The response generation module 20 may be configured to generate an appropriate response to the user based on the result of intent classification. This may include rule-based template responses, selection from a group of response candidates, or dynamic response generation through integration with external systems. Further, the logging and monitoring module 30 may support service quality management and problem diagnosis by recording and monitoring user inputs, classification results, generated responses, and system operating state.

The intent classification module 10 may be configured to classify the semantic intent of a user input query in the form of natural language input from a user. For example, the intent classification module 10 may utilize the instruction inference capability of the large language model LLM to enable accurate intent classification through a fixed format prompt that includes an example of one-shot for each intent, even for a new domain.

Referring to FIG. 6, the intent classification module 10 may include a domain classification module 11, a prompt generation module 12, and an LLM-based intent inference module 13.

The domain classification module 11 may perform a domain classification task to identify a domain to which a user input query belongs. The domain classification module 11 may be configured to determine whether a user input query belongs to one of a plurality of predefined domains based on the semantic content and expression characteristics of the query.

The domain classification module 11 may perform domain classification. For example, the domain classification module 11 may classify an user input query “How much is left in my bank account?” into a “Finance” domain, or classify an user input query “What's the name of this song?” into a “Music” domain. This domain information serves as an essential basis for constructing the prompt that includes one-shot samples for each intent suitable for the corresponding domain in the prompt generation module 12.

For example, the domain classification module 11 may apply a rule-based method that classifies the domain by matching specific keywords or keyword patterns (e.g., “medicine”, “dosage”, “symptom”, “account”, “exchange rate”, etc.) included in the user input query with predefined domain-specific keyword sets.

Further, the domain classification module 11 utilizes the instruction inference capability of the large language model that may contextually analyze an entire sentence to construct a natural language-based prompt including a predefined domain list and example sentences for the domains. This enables the domain to be directly inferred in the form of a question such as “Which domain does this query belong to?”

Furthermore, the domain classification module 11 may use a vector-based similarity method that converts the user input query into a high-dimensional vector through a sentence embedding technique such as Sentence Bidirectional Encoder Representations from Transformers (SBERT) or BAAI General Embedding (BGE), calculates the cosine similarity with a representative sentence or template embedding corresponding to each domain, and selects the most similar domain. In this case, the final domain selection may be determined through a simple classifier such as k-Nearest Neighbors (k-NN) or softmax classifier, taking the similarity-based filtering result as input.

As such, the domain classification module 11 may be implemented using a single algorithm or various algorithms in combination, and each method may be selectively applied depending on the complexity of the domain, keyword separability, and model resource status.

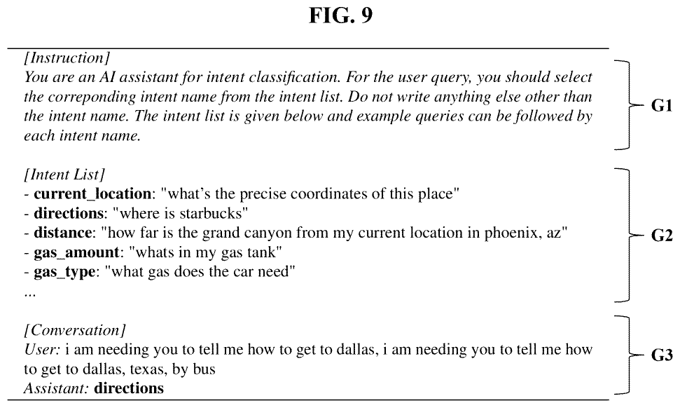

The prompt generation module 12 may automatically generate the natural language-based prompt that may be processed by the large language model (LLM) to perform appropriate intent classification for the user input query. The prompt follows a fixed configuration format and, as illustrated in FIG. 9, may include an intent classification task instruction G1, an intent information list G2 including a plurality of intent information pairs, and conversation information G3.

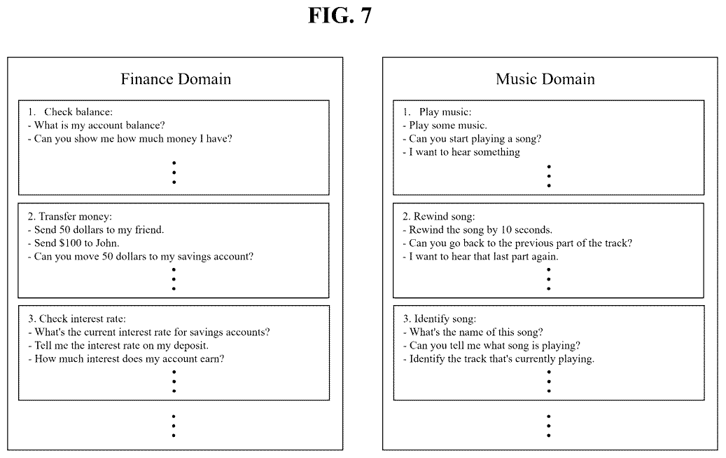

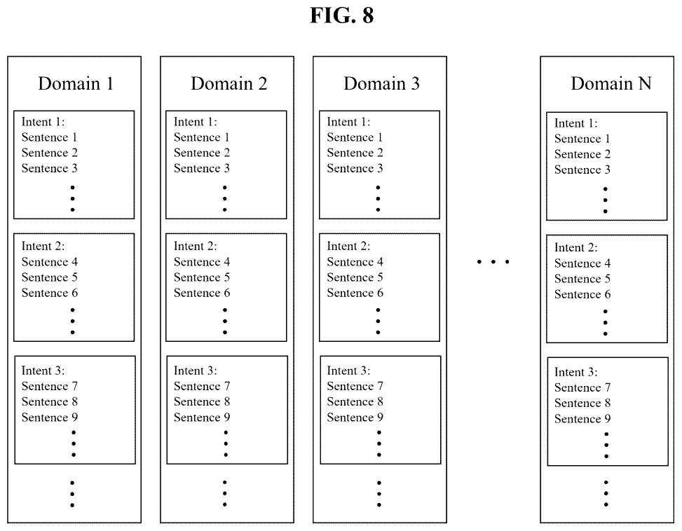

The prompt generation module 12 may first select one representative sample sentence for each of a plurality of intent labels belonging to a domain from the domain-specific intent database stored in the memory. For example, referring to FIGS. 7 and 8, the domain-specific intent database includes, for each of a plurality of domains (e.g., Finance domain and Music domain), intent labels and a plurality of sample sentences corresponding to each intent label. The sample sentences may be configured in a structure similar to actual user queries expressed in natural language.

For example, a plurality of intent labels defined for each domain and a plurality of sample sentences corresponding to each intent label may be stored and managed in a structured form, and may be stored in, for example, JavaScript Object Notation (JSON) format. The JSON has the advantage of being able to express hierarchical data, being highly readable, and being universally usable across various programming languages and system environments.

To be more specific, each domain may be defined as a top-level key of a JSON object, each intent label within that domain may be set as a sub-key, and each intent label key may be mapped to an array of a plurality of example sentences. For example, the intent label for check balance in the finance domain may be structured as ‘finance: {check_balance: [What is my account balance?, Can you show me how much money I have?]}’.

The JSON-based storage structure may enable efficient data access and manipulation for the prompt generation module 12 to dynamically select and configure intent sample sentences corresponding to the domain and intent labels. The JSON-based storage structure may simplify the automatic prompt generation logic and enhance system expandability.

The prompt generation module 12 may generate domain-specific prompts using intent sample sentences selected from the domain-specific intent database.

For example, referring to FIG. 9, the prompt may include an intent classification task instruction G1 that specifies the task to be performed by the language model, an intent information list G2 including a plurality of intent information pairs, each of which includes an intent label related to a corresponding domain and an intent sample sentence corresponding to the intent label, and conversation information G3 including a query related to the same domain as the plurality of intent information pairs and a correct intent label for the query.

The intent classification task instruction G1 may comprise a natural language sentence that specifies the purpose and output format of the task to be performed by the large language model. For example, the intent classification task instruction G1 may include a sentence such as “You are an AI assistant for intent classification. For the user query, you should select a corresponding intent name from the intent list . . . ”, which restricts the large language model to return only the intent name as output and instructs how to utilize the input and reference information.

The plurality of intent information pairs included in the intent information list G2 may be generated by matching the plurality of intent labels with the intent sample sentence corresponding to each intent label. These intent information pairs enable the large language model to distinguish semantic differences between different intents, and may be generated based on the intent-specific sample sentence selected from the domain-specific intent database.

In this case, a single sample sentence is matched to each intent label, resulting in the creation of a plurality of intent information pairs. This allows for the construction of the one-shot prompt. By pre-training the large language model using the one-shot prompt, effective intent classification can be achieved with only a small number of examples, even in new or unseen domains.

The conversation information G3 may include a query and a corresponding correct intent label for the same domain as that of a plurality of intent information pairs included in the intent information list G2.

This conversation information G3 may be included, for example, in a block structure such as [Conversation], and may include a query that may correspond to a user utterance and an assistant response that includes only the intent label in the form of a response thereto.

For example, the conversation information G3 may be structured in the format of “User: I am needing you to tell me how to get to Dallas, Texas, by bus/Assistant: directions”, thereby allowing the large language model to learn or infer a mapping relationship between the query and its correct intent label in a natural language-based manner.

In particular, the conversation information G3 may induce the large language model to generalize classification performance for flexible sentence representations by including various expression variations close to actual user input queries.

In this way, the prompt generation module 12 may generate the prompt in the natural language format, which integrates the intent classification task instruction G1, the intent information list G2, and the conversation information G3. This prompt may be input to the large language model (LLM) and utilized for pre-learning or inference for intent classification.

An LLM-based intent inference module 13 may receive the prompt as input and infer the intent label corresponding to the user input query through the large language model. The inference may be performed by calling a cloud-based LLM through an external API. At this time, the LLM-based intent inference module 13 may accurately determine the intent of the user input query, even in cases involving ambiguous expressions or high context dependency, based on the fixed-format prompt.

The response generation module 20 may generate a response to be provided to the user according to the determined intent, after the intent for the user input query is determined by the intent classification module 10.

The response generation module 20 may perform a key processing step for improving the quality of interaction with the user, and may generate responses in various ways according to the intent label and a service scenario associated with the intent label.

In detail, the response generation module 20 may be implemented in a predefined template-based response generation method. In this case, a structured response corresponding to the intent may be quickly constructed by referring to a database or rule set in which response sentence templates mapped to intent labels are stored.

For example, when the intent label “cancel_order” is derived, a final response may be generated by inserting user information or system query results into a template such as “Your cancellation request for order number {{order_id}} has been received.” This method provides the advantages of fast processing speed and consistent service responses.

Further, the response generation method performed by the response generation module 20 may be implemented in the form of integration with external systems.

For example, when an intent such as “track_order” is determined, the determined intent may be integrated with an actual delivery tracking system or order management API to retrieve real-time state information and then generate a dynamic response based on the retrieved information.

For example, a response such as “Your product has just departed from the Gangnam Logistics Center in Seoul” may be automatically generated. Such a configuration facilitates integration with existing backend systems within the enterprise and is advantageous in enhancing the accuracy of responses.

Further, the response generation method of the response generation module 20 may be implemented as the natural language response generation method using the LLM. In this case, after creating a structured prompt that includes the determined intent label and the user input query, the prompt may be input into the LLM to directly generate a response sentence in natural language form.

For example, when the query “I want to cancel my order” and the corresponding intent “cancel_order” are provided, a response such as “Your cancellation request has been confirmed. Please enter the specific order number.” may be automatically generated.

This method offers the advantage of enabling flexible responses in situations where expression diversity and naturalness are required, or when handling exceptional queries.

As such, according to various embodiments, the response generation module 20 may be implemented using a template-based method, an external integration method, an LLM-based method, or a hybrid configuration that combines one or more of these methods. For example, frequently recurring FAQ-type user input queries may use template-based responses, while open-ended questions or situations requiring inference may use the LLM-based response generation. This hybrid configuration can enhance both response generation efficiency and user satisfaction.

The logging and monitoring module 30 may be configured to collect and record input and output data across the entire system to ensure stable operation and improve the quality of the chatbot service. For example, the logging and monitoring module 30 may store the user input query, the prompt generated by the intent classification module 10, the intent information determined for the user input query, the final response message generated by the response generation module 20, and the like. This data is stored in chronological order and may serve as a foundational resource for subsequent analysis, quality inspection, and incorporation of user feedback.

Further, the logging and monitoring module 30 continuously monitors or observes the system's state and may detect anomalies based on specific criteria (e.g., error occurrence rate, response timeouts, LLM inference failures, etc.), and send notifications to an administrator when such events occur. Furthermore, the logging and monitoring module 30 may perform statistical analysis on intent classification accuracy or response appropriateness, and generate quality metrics related to inference results (e.g., confidence score distribution, intent mismatch frequency, etc.), thereby enabling indirect evaluation of model performance. These functions play an important role in quickly responding to errors during service operation and quantitatively improving the performance of the chatbot system.

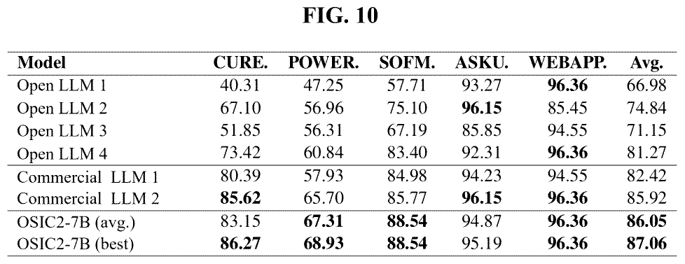

FIG. 10 is a table showing performance evaluation results of one-shot intent classification performed using a large language model trained based on a predetermined prompt for various domains, according to an embodiment.

The intent classification model for the domain-adaptive intent classification based on the large language model according to various embodiments of the present disclosure is referred to as “OSIC2-7B”, and comparative models for comparison include publicly available small- and medium-sized language models, as well as commercially available high-performance language models.

To evaluate the intent classification performance of OSIC2-7B according to various embodiments of the present disclosure and the comparative models, the comparative experiments of the intent classification performance were conducted on each model using five unseen benchmark datasets: CUREAKART (CURE.), POWERPLAY11 (POWER.), SOFMATTRESS (SOFM.), ASKUBUNTU (ASKU.), and WEBAPPLICATIONS (WEBAPP.).

Each dataset contains more than 20 unique intent labels and reflects the complexity and domain characteristics of real applications, making them suitable for quantitatively evaluating the domain adaptability and generalization capability of intent classification models.

As a result of performing the intent classification for each model, the OSIC2-7B model, according to various embodiments of the present disclosure, achieved an average accuracy of 86.05% (avg.) and a best accuracy of 87.06% (best), surpassing the performance of Commercial LLM 2, which recorded an accuracy of 85.92%. In particular, the OSIC2-7B model demonstrated high accuracy across various unseen domains, achieving 96.36% on the WEBAPP.domain, 95.19% on the ASKU.domain, and 88.54% on the SOFM.domain, thereby validating consistent performance across diverse unseen domains. This demonstrates that the Demonstrative Instruction Tuning (DIT)-based learning architecture proposed in an embodiment of the present disclosure effectively enhances domain generalization performance.

### -Method S100 for Providing Domain-Adaptive Chatbot Service Based on Large Language Model

The following describes in detail the method S100 for providing the domain-adaptive chatbot service based on the large language model (LLM), which enables high-performance and flexible intent classification even for new or unseen domains. To efficiently perform intent classification tasks across a plurality of domains, the method S100 may include generating a structured prompt that includes intent labels and sample sentences for each domain using the LLM based on the prompt to infer the intent of the user input query, and performing a series of processes—such as domain classification, prompt generation, and LLM-based inference—based on the user input query to enhance the accuracy of the inference results.

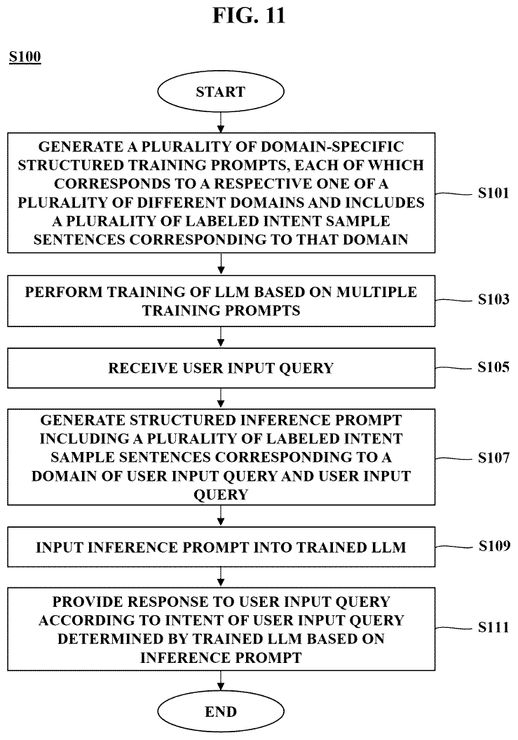

FIG. 11 is a flowchart illustrating the method S100 for providing the domain-adaptive chatbot service based on the large language model according to an embodiment.

Referring to FIG. 11, the method S100 for providing the domain-adaptive chatbot service based on the large language model according to an embodiment may include one or more of step S101 of generating a plurality of domain-specific structured training prompts, each of which corresponds to a respective one of a plurality of different domains and includes a plurality of labeled intent sample sentences corresponding to that domain, step S103 of performing training of the LLM based on the plurality of training prompts, step S105 of receiving a user input query, step S107 of generating a structured inference prompt including a plurality of labeled intent sample sentences corresponding to the domain of the user input query and the user input query, step S109 of inputting the inference prompt into the trained LLM, and step S111 of providing a response to the user input query according to the intent of the user input query determined by the trained LLM based on the inference prompt.

In an embodiment, the method S100 may be performed by the processor 131 included in the server computing system 130. However, the method according to the present disclosure is not limited thereto. For example, one or more operations of the method S100 may be performed by the processor 111 of the user computing device 110, while the remaining operations of the method S100 may be performed by the processor 131 of the server computing system 130.

Hereinafter, an embodiment in which the method S100 is performed by the processor 131 of the server computing system 130 will be described, but a person having ordinary skill in the art would implement another embodiment in which the method S100 described below can be performed by a plurality of processors.

In step S101, the processor 131 of the server computing system 130 may generate the plurality of fixed-format training prompts, each structured by domain, based on a dataset including a plurality of labeled intent sample sentences for a plurality of intents belonging to each domain. Here, each training prompt may include a structure in which a plurality of intent labels belonging to a corresponding domain are stored with or listed along with sample sentences corresponding to each intent label.

For example, as described with reference to FIG. 9, each of a plurality of training prompts may include the intent classification task instruction G1 that specifies the task to be performed by the language model, the intent information list G2 including a plurality of intent information pairs, each of which includes the intent label related to a corresponding domain and the intent sample sentence corresponding to the intent label, and the conversation information G3 including the query related to the same domain as the plurality of intent information pairs and the correct intent label for the query.

However, in the case where the model is trained using the fine-tuning method, the correct intent label corresponding to the user query included in the conversation information G3 may be provided as ground truth data, which serves as the output target of the model during LLM training.

For example, a query such as “User: I need you to tell me how to get to Dallas . . . ” included in the conversation information G3 of FIG. 9 may be included in the training prompt, while the corresponding correct intent label “directions” may be excluded from the training prompt and instead provided separately as the ground truth data, serving as the output target of the model.

In step S101, the processor 131 of the server computing system 130 may repeatedly generate a plurality of structured prompts including different intent sample sentences at least a predetermined number of times (e.g., three times) by maintaining the same intent label for the same domain but configuring the intent sample sentences corresponding to the intent label differently each time.

For example, the step S101 may include one or more of a step of generating a first plurality of domain-specific structured training prompts, each of which corresponds to a respective one of a plurality of different domains and includes a plurality of first labeled intent sample sentences corresponding to that domain, and a step of generating a second plurality of domain-specific structured training prompts, each of which corresponds to a respective one of a plurality of different domains and includes a plurality of second labeled intent sample sentences corresponding to that domain. Here, a first intent sample sentence for a first intent included in a training prompt corresponding to a first domain among the first plurality of training prompts may be different from a second intent sample sentence for the first intent included in a training prompt corresponding to the same first domain among the second plurality of training prompts.

In this case, each structured prompt includes, in a one-shot format, a plurality of intent labels defined within the same domain along with different sample sentences corresponding to each label. By utilizing a plurality of prompts with different sample sentences for the same domain during training, the LLM may learn a wider variety of expression styles and semantic contexts, thereby effectively improving its domain adaptation performance.

Such a configuration can apply iterative prompt generation for each of a plurality of domains, and induce the LLM to have generalization ability in real usage environments without overfitting to a single example through diversity in the selection of intent sample sentences.

In step S103, the processor 131 of the server computing system 130 may perform training for intent classification for the LLM based on the plurality of training prompts generated in step S101.

At this step, the training may be conducted using a fine-tuning method in which parameters of the model are updated by inputting a plurality of training prompts into the LLM, or an in-context learning method in which the LLM is temporarily adapted to the prompt format of a unseen domain by inputting the training prompts into the LLM while the model parameters remain fixed or unchanged.

Here, the in-context learning method may refer to a learning method in which the intent classification method is internalized in the LLM in a context-dependent manner by inputting the plurality of structured training prompts—each corresponding to a different domain and including a plurality of labeled intent sample sentences—into the LLM.

Depending on the learning method, the structure of the training prompts and the method of providing ground truth data may vary. For example, in the fine-tuning method, the user query included in the conversation information G3 is used as input within the training prompt, while the corresponding intent label is excluded from the prompt and instead provided separately as ground truth data. However, in the in-context learning method, the conversation information G3, including the intent label, is incorporated into the prompt, and the model is guided to infer the intent of subsequent user inputs based on this information. In this case, the LLM temporarily learns the pattern of intent classification from the in-context example while keeping its model parameters fixed.

Meanwhile, in training step S103, the processor 131 of the server computing system 130 may perform training by repeatedly inputting a plurality of training prompts including different intent sample sentences for the same intent label of the same domain generated in step S101 into the LLM.

For example, if a plurality of intent labels such as “check_balance,” “transfer_money,” and “report_fraud” are defined for a specific domain (e.g., the finance domain), then first, second, and third structured training prompts—each containing different sample sentences for each intent label—may be generated and sequentially input into the LLM to perform the training.

This method encourages the model to acquire more generalized intent inference capabilities by using examples that reflect diverse expression styles and sentence structures, even within the same domain, as training data. In particular, compared to a method that uses only a single fixed sample sentence, this method allows the model to learn a variety of similar but distinct sentence patterns, thereby achieving greater adaptability and higher intent classification accuracy for actual user input queries.

In step S105, the processor 131 of the server computing system 130 receives a user input query in a natural language form from the user computing device 110. This user input query is a user's utterance or question, and may include information requests, commands, or questions corresponding to a specific intent within a specific domain.

In step S107, the processor 131 of the server computing system 130 may perform a domain classification task on the received user input query, select a plurality of labeled intent sample sentences corresponding to the domain of the determined user input query, and generate a structured inference prompt including these sample sentences and the user input query.

In this step, as described with reference to FIG. 9, each of a plurality of training prompts may include the intent classification task instruction G1 that specifies the task to be performed by the language model, the intent information list G2 including a plurality of intent information pairs, each of which includes the intent label related to the corresponding domain and the intent sample sentence corresponding to the intent label, and the conversation information G3 including the query related to the same domain as the plurality of intent information pairs and the correct intent label for the query.

Here, the query included in the conversation information G3 corresponds to the user input query entered by an actual user, and the large language model is configured to predict the appropriate intent label based on this query.

Further, the correct intent label corresponding to the user query included in the conversation information G3 is excluded from the inference prompt. This is because, during the inference step S107, the large language model should predict and output the appropriate intent label on its own based on the user input query included in the inference prompt.

In step S109, the processor 131 of the server computing system 130 inputs the generated inference prompt into the LLM trained in step S103. The LLM contextually analyzes the intent sample included in the input prompt and the user input query to infer the semantic intent of the given user input query.

In step S111, the processor 131 of the server computing system 130 may verify the result derived by the trained LLM based on the inference prompt, generate or select a response according to the intent of the user input query determined as the result, and transmit the response to the user computing device 110. The generated response may include a response template pre-mapped to the corresponding intent or the result of an API call.

The above-described domain-adaptive chatbot service providing method S100 based on the LLM according to an embodiment of the present disclosure may include a series of steps: generating structured training prompts corresponding to a plurality of domains, performing domain adaptation training of the LLM using either the fine-tuning or in-context learning method based on the generated prompts, and then deriving an appropriate intent classification result by performing domain classification and generating the inference prompt for the user input query.

For example, by utilizing the structured training prompts that include domain-specific intent labels and intent sample sentences, along with inference prompts constructed based on an actual user input query corresponding to a new or unseen domain, an intent classification model can flexibly adapt to the new or unseen domain.

Accordingly, the method S100 according to various embodiments of the present disclosure can improve intent classification accuracy for domains that have not been pre-trained, using only a fixed prompt format. The method S100 according to some embodiments of the present disclosure also enables both enhanced domain scalability of the LLM and flexible chatbot response quality. In addition, the structured format of a training and inference prompt configuration method according to certain embodiments of the present disclosure can provide a foundation for implementing a scalable chatbot system that can be reused across various industries.

The above-described embodiments of the present disclosure can be implemented in the form of program instructions that can be executed through various computer components and recorded on a computer-readable recording medium. The computer-readable recording medium may include program instructions, data files, data structures, etc., alone or in combination. The program instructions recorded on the computer-readable recording medium may be specially designed and configured for the present disclosure or may be known and available to those skilled in a computer software field. Examples of the computer-readable recording medium include magnetic media such as hard disks, floppy disks, and magnetic tape, optical storage media such as CD-ROMs and DVDs, magneto-optical media such as floptical disks, and hardware devices specifically configured to store and execute program instructions, such as ROM, RAM, and flash memory. Examples of the program instructions include not only machine language code produced by a compiler, but also high-level language code that can be executed by a computer using an interpreter, etc. The hardware device may be modified into one or more software modules to perform processing according to the present disclosure, and vice versa.

Specific implementations described in the present disclosure are merely exemplary and do not limit the scope of the present disclosure in any way. For the sake of brevity in the specification, descriptions of conventional electronic components, control systems, software, and other functional aspects of the systems may be omitted. Further, connections or connection members of lines between components shown in the drawings are merely illustrative of functional and/or physical or circuit connections. In an actual device, they may be replaced or represented by various additional functional, physical, or circuit connections. Unless explicitly stated otherwise, such as with “essential” or “important,” a component may not be necessarily required for the application of the present disclosure.

Although the detailed description of the present disclosure has been provided with reference to preferred embodiments, those skilled in the art or having ordinary knowledge in the relevant technical field will understand that various modifications and changes can be made to the present disclosure without departing from the spirit and technical scope defined by the claims below. Accordingly, the technical scope of the present disclosure should not be limited to the detailed description of the specification but should be determined by the claims.

What is claimed is:

1. A method for providing a domain-adaptive chatbot service based on a large language model (LLM), the method comprising:
generating a plurality of domain-specific structured training prompts, wherein each of the plurality of domain-specific structured training prompts corresponds to a respective one of a plurality of different domains and includes a plurality of labeled intent sample sentences corresponding to the respective one of the plurality of different domains;
training the LLM based on the plurality of domain-specific structured training prompts;
receiving a user input query;
generating a structured inference prompt including a plurality of labeled intent sample sentences corresponding to a domain of the user input query and the user input query;
inputting the inference prompt into the trained LLM to determine an intent of the user input query; and
providing a response to the user input query according to the intent of the user input query determined by the trained LLM based on the inference prompt.

2. The method of claim 1, wherein each of the plurality of domain-specific structured training prompts comprises an intent classification task instruction.

3. The method of claim 1, wherein each of the plurality of domain-specific structured training prompts comprises a plurality of intent information pairs, each of the intent information pairs including an intent label related to a corresponding domain and an intent sample sentence corresponding to the intent label.

4. The method of claim 3, wherein each of the plurality of domain-specific structured training prompts further comprises a query related to a same domain as the plurality of intent information pairs.

5. The method of claim 4, wherein the training of the LLM comprises:
training the LLM using the intent label corresponding to the query as ground truth data.

6. The method of claim 1, wherein the generating of the structured inference prompt comprises:
determining the domain of the user input query; and
generating the structured inference prompt comprising a plurality of intent information pairs, each of the intent information pairs including an intent label related to the determined domain of the user input query and an intent sample sentence corresponding to the intent label.

7. The method of claim 1, wherein the generating of the plurality of domain-specific structured training prompts comprises:
generating a first plurality of domain-specific structured training prompts, each corresponding to a respective one of a plurality of different domains and including a plurality of first labeled intent sample sentences corresponding to the respective one of the plurality of different domains; and
generating a second plurality of domain-specific structured training prompts, each corresponding to a respective one of a plurality of different domains and including a plurality of second labeled intent sample sentences corresponding to the respective one of the plurality of different domains,
wherein a first intent sample sentence for a first intent included in a domain-specific training prompt corresponding to a first domain among the first plurality of domain-specific training prompts is different from a second intent sample sentence for the first intent included in a domain-specific training prompt corresponding to the first domain among the second plurality of domain-specific training prompts.

8. The method of claim 7, wherein the training of the LLM comprises:
training the LLM based on the first plurality of domain-specific training prompts; and
training the LLM based on the second plurality of domain-specific training prompts.

9. A system for providing a domain-adaptive chatbot service based on a large language model (LLM), the system comprising:
memory configured to store one or more instructions; and
at least one processor configured to execute the one or more instructions stored in the memory and comprising:
generating a plurality of domain-specific structured training prompts, wherein each of the plurality of domain-specific structured training prompts corresponds to a respective one of a plurality of different domains and includes a plurality of labeled intent sample sentences corresponding to the respective one of the plurality of different domains;
training the LLM based on the plurality of domain-specific structured training prompts;
receiving a user input query;
generating a structured inference prompt including a plurality of labeled intent sample sentences corresponding to a domain of the user input query and the user input query;
inputting the inference prompt into the trained LLM to determine an intent of the user input query, and
providing a response to the user input query according to the intent of the user input query determined by the trained LLM based on the inference prompt.

10. The system of claim 9, comprising:
a plurality of neurons configured as an array including at least one register, at least one programmable logic, and at least one input interface;
a plurality of synapse circuits configured to store a synapse weight for adjusting a connection strength between the plurality of neurons; and
at least one routing network configured to control data flow between the plurality of neurons,
wherein each of the plurality of neurons comprises a field programmable gate array (FPGA) for an artificial neural network, which is connected to at least one other neuron of the plurality of neurons via the routing network to establish a transmission path of the synapse weight for adjusting the connection strength between the plurality of neurons.

11. The system of claim 9, comprising:
a plurality of neurons configured as an array including at least one register, at least one microprocessor, and at least one input; and
a plurality of synapse circuits configured to store a synapse weight for adjusting a connection strength between the plurality of neurons,
wherein each of the plurality of neurons comprises an application-specific integrated circuit (ASIC) for an artificial neural network, which is connected to at least one other neuron of the plurality of neurons via one of the plurality of synapse circuits.
